(19) United States
(12) Patent Application Publication
(10) Pub. No.: US 2009/0168900 A1
(43) Pub. Date: Jul. 2, 2009

(54) ENCODING APPARATUS, ENCODING METHOD, AND PROGRAM

(76) Inventors: Hiroyasu SHIMOYAMA, Tokyo (JP); Yutaka Hasegawa, Kanagawa (JP); Kayo Horiuchi, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/329,712

(22) Filed: Dec. 8, 2008

(30) Foreign Application Priority Data
Dec. 27, 2007 (JP) 2007-337264

(51) Int. Cl. H04N 7/26

(52) U.S. Cl. 375/240.26; 375/E07.2

(57) ABSTRACT

An encoding apparatus is disclosed which puts picture data into encoded data formed by a plurality of layers conforming to a predetermined standard by use of a hypothetical buffer, the encoding apparatus including: an analysis section configured to calculate an access unit occupancy of the hypothetical buffer for each of the layers in order to determine whether constraints on the hypothetical buffer are met; and an encoding section configured to put the picture data into encoded data in compliance with the predetermined standard on the basis of a result of the analysis; wherein, if the constraint in a second layer is considered to be met provided the constraint on the hypothetical buffer in a first layer is met, then the analysis section calculates the access unit occupancy only for the first layer in order to determine whether the constraints on the hypothetical buffer are met.

### CROSS REFERENCES TO RELATED APPLICATIONS

The present invention contains subject matter related to Japanese Patent Application JP 2007-337264 filed in the Japan Patent Office on Dec. 27, 2007, the entire contents of which being incorporated herein by reference.

### BACKGROUND OF THE INVENTION

1. Field of the Invention

The present invention relates to an encoding apparatus, an encoding method, and a program for encoding picture data by use of hypothetical decoders.

2. Description of the Related Art

Today, some encoders are known to have adopted the concept of hypothetical decoders designed to prevent buffer overflow and underflow that may occur while bit streams are being encoded. One such encoder is disclosed illustratively in Japanese Patent Laid-Open No. 2007-59996. In order to ensure reproduction of pictures at the transfer rate defined by the picture format in use, such encoders have also introduced the concept of a buffer model representative of the hypothetical decoder model as well as the concept of buffer conformance in compliance with the buffer model.

The buffer model, as shown in FIG. 10A, is one in which picture data is input at a predetermined transfer rate and decoded for consumption in a specifically timed manner. Particular conditions may be added depending on the picture format in effect.

Buffer conformance denotes the degree of compliance with the buffer model defined for picture data by the picture format in use. For example, buffer conformance is not met in three cases: when insufficient picture data is being buffered upon start of decoding as shown at point “a” in FIG. 10B (i.e., underflow); when picture data is being input in excess of the predetermined buffer size as shown at point “b” in FIG. 10B (overflow); or when buffer capacity guaranty information is not met at a particular point in time as shown at point “c” in FIG. 10C.

### SUMMARY OF THE INVENTION

Where picture data is encoded using the above-mentioned hypothetical decoding scheme, the encoder needs to make calculations with regard to all constraints in effect (i.e., buffer conformance) to make sure that all constraints are being met. The process involved is a time-consuming exercise. When all constraints are to be met, the strictest constraint sets the norm to be satisfied. This puts a limit to the buffer usage for re-encoding purposes, which can entail degradation of pictures during re-encoded rendering intervals.

The present invention has been made in view of the above circumstances and provides an encoding apparatus, an encoding method, and a program for acquiring encoded data of enhanced picture quality at high speeds.

In carrying out the present invention and according to one embodiment thereof, there is provided an encoding apparatus for putting picture data into encoded data formed by a plurality of layers conforming to a predetermined standard by use of a hypothetical buffer which hypothetically models buffer status of a decoding apparatus, the encoding apparatus including: analysis means for calculating an access unit occupancy of the hypothetical buffer for each of the layers in order to determine through analysis whether constraints on the hypothetical buffer are met; and encoding means for putting the picture data into encoded data in compliance with the predetermined standard on the basis of a result of the analysis; wherein, if the constraint on the hypothetical buffer in a second layer is considered to be met provided the constraint on the hypothetical buffer in a first layer is met, then the analysis means calculates the access unit occupancy only for the first layer in order to determine whether the constraints on the hypothetical buffer are met.

According to another embodiment of the present invention, there is provided an encoding method for putting picture data into encoded data formed by a plurality of layers conforming to a predetermined standard by use of a hypothetical buffer which hypothetically models buffer status of a decoding apparatus, the encoding method including the steps of: calculating an access unit occupancy of the hypothetical buffer for each of the layers in order to determine through analysis whether constraints on the hypothetical buffer are met; and putting the picture data into encoded data in compliance with the predetermined standard on the basis of a result of the analysis; wherein, if the constraint on the hypothetical buffer in a second layer is considered to be met provided the constraint on the hypothetical buffer in a first layer is met, then the calculating step calculates the access unit occupancy only for the first layer in order to determine whether the constraints on the hypothetical buffer are met.

According to a further embodiment of the present invention, there is provided a program for causing a computer to execute a procedure for putting picture data into encoded data formed by a plurality of layers conforming to a predetermined standard by use of a hypothetical buffer which hypothetically models buffer status of a decoding apparatus, the procedure including the steps of: calculating an access unit occupancy of the hypothetical buffer for each of the layers in order to determine through analysis whether constraints on the hypothetical buffer are met; and putting the picture data into encoded data in compliance with the predetermined standard on the basis of a result of the analysis; wherein, if the constraint on the hypothetical buffer in a second layer is considered to be met provided the constraint on the hypothetical buffer in a first layer is met, then the calculating step calculates the access unit occupancy only for the first layer in order to determine whether the constraints on the hypothetical buffer are met.

According to the embodiments of the present invention, if the constraint on the hypothetical buffer in the second layer is considered to be met provided the constraint on the hypothetical buffer in the first layer is met, then the access unit occupancy need only be calculated for the first layer in determining whether the constraints on the hypothetical buffer are met. This scheme provides high-speed acquisition of encoded data with enhanced picture quality.

### BRIEF DESCRIPTION OF THE DRAWINGS

Further advantages according to the embodiments of the present invention will become apparent upon a reading of the following description and appended drawings in which:

FIG. 1 is a schematic view illustrating typical CPB (coded picture buffer) performance;

FIG. 2 is a schematic view indicating CPB usages for NAL (network abstraction layer) and VCL (video coding layer) access units;

FIG. 3 is a block diagram showing a typical hardware structure of an editing apparatus embodying the present invention;

FIGS. 4A and 4B are graphic representations explaining an RR (re-encoded rendering) interval and a usable data amount;

FIG. 5 is a schematic view showing how an RR interval length is set;

FIG. 6 is a schematic view showing typical buffer occupancies in effect when the NAL and VCL have the same bit rate;

FIG. 7 is a functional block diagram outlining the function for determining the re-encoded rendering interval;

FIG. 8 is a tabular view explaining how the RR interval length is determined;

FIG. 9 is a flowchart of steps constituting an editing process; and

FIGS. 10A, 10B and 10C are schematic views illustrating ordinary buffer performance.

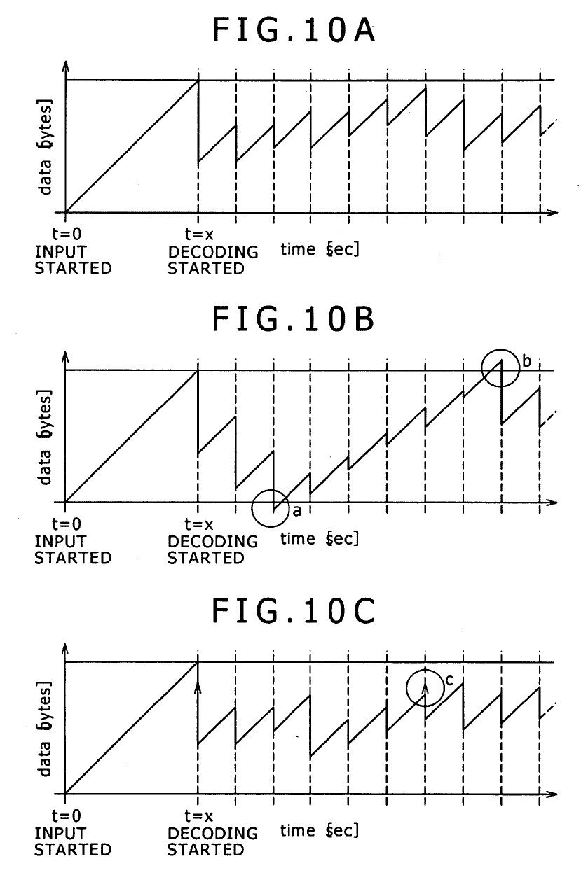

### DETAILED DESCRIPTION OF THE PREFERRED EMBODIMENTS

The preferred embodiments of the present invention will now be described in detail with reference to the accompanying drawings. An encoding apparatus described below and embodying the invention involves encoding moving pictures in compliance with H.264/AVC (ISO MPEG-4 Part 10 Advanced Video Coding).

H.264/AVC defines two layers: VCL (video coding layer) for dealing with the process of encoding moving pictures, and NAL (network abstraction layer) positioned between the VCL and a subordinate system for transmitting and accumulating encoded information. A bit stream stricture is also defined in which the VCL and NAL are kept apart.

H.264/AVC further defines the hypothetical decoder model called HRD (hypothetical reference decoder) for generating picture bit streams in such a manner that the encoder will not disable the buffer of the decoder. The HRD stipulates a CPB (coded picture buffer) in which to accommodate the bit stream before it is input to the decoder. Data in access units (AU) for the VCL and NAL is input by a hypothetical stream scheduler (HSS) to the CPB at predetermined times of arrival. The data in each access unit is removed instantaneously from the CPB at a CPB removal time at which the data in each of the access units is to be retrieved from the CPB. The removed data is decoded instantaneously by the hypothetical decoder.

Information about the HRD is transmitted by a sequence parameter set (SPS). Information about HRD performance is transmitted using buffering interval SEI (supplemental enhancement information) and picture timing SEI. The SEI constitutes supplemental information not directly related to the process of decoding bit streams.

According to H.264/AVC, the buffer conformance of the CPB for each of the NAL and VCL needs to be satisfied individually. The check items for CPB buffer conformance include an overflow check, an underflow check, and an initial_cpb_removal_delay check. The overflow check is unnecessary if a variable bit rate (VBR) is in effect.

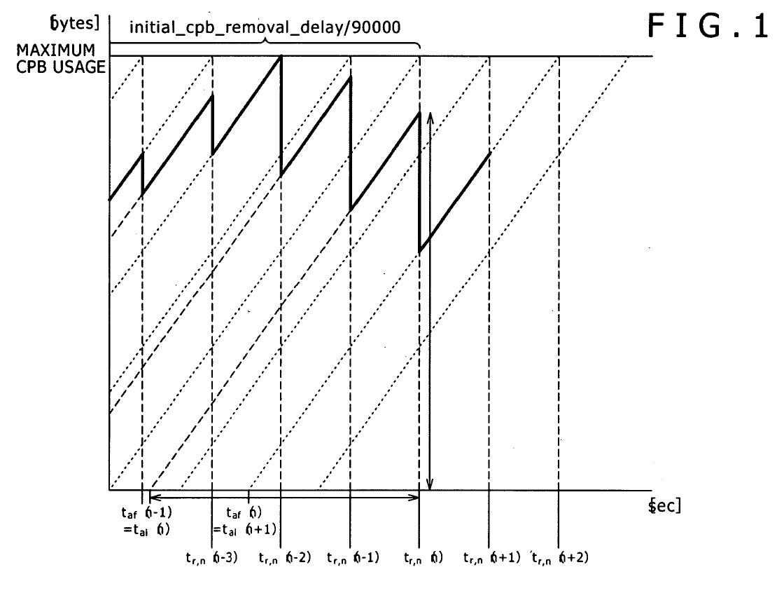

FIG. 1 schematically illustrates typical CPB (coded picture buffer) performance. In FIG. 1, tₐᵢ(n) denotes the time at which an n-th access unit (AU) starts flowing into the CPB; t_{af}(n) represents the time at which the flow of the n-th AU into the CPB is complete; and t_{r,n}(n) stands for the time at which the n-th AU is removed from the CPB.

The initial_cpb_removal_delay denotes a delay time period at the end of which the initial access unit of the bit stream is removed from the buffer. That is, the initial_cpb_removal_delay indirectly stands for the amount of data being accumulated in the buffer at a given point in time. The larger the delay value, the greater the amount of data being stored in the buffer at that point in time.

Where the variable bit rate (VBR) is in effect, the initial_cpb_removal_delay check determines whether the expression shown below is satisfied. In other words, a check is made to determine if the initial_cpb_removal_delay is equal to or less than a rounded-up integer of Δtg, 90 (n). The expression is:

initial_{—}cpb_removal_delay≦Ceil(Δtg,90(n))

where, Δtg,90(n)=90000·(tr,n(n)−taf(n−1)).

Where a constant bit rate (CBR) is in effect, the initial_cpb_removal_delay check determines whether the expression shown below is satisfied. In other words, a check is made to determine if the initial_cpb_removal_delay is equal to or greater than a rounded-down integer of Δtg,90(n) and if the initial_cpb_removal_delay is equal to or smaller than the rounded-up integer of Δtg, 90 (n). The expression is:

Floor(Δtg,90(n))<=initial_{—}cpb_removal_delay<=Ceil(Δtg,90(n))

The NAL and VCL input to the CPB have different access unit (AU) sizes. It follows that a different syntax rate and a different initial_cpb_removal_delay may be designated for each of the NAL and VCL by SPS and buffering interval SEI. Bit rate conformance needs to be calculated and the constraints involved need to be met separately for each of the two layers.

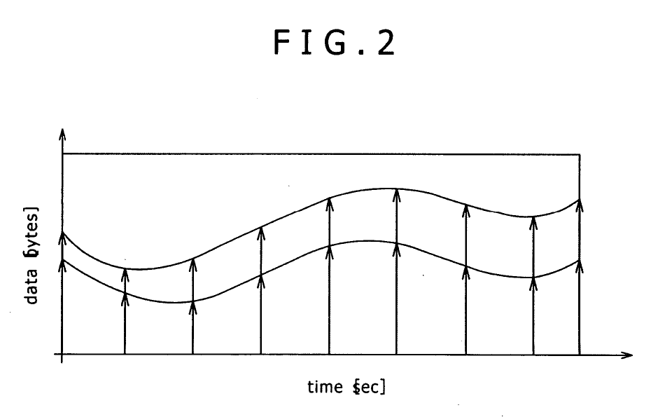

FIG. 2 schematically indicates CPB usages for NAL and VCL access units. If the NAL and VCL have the same syntax bit rate, the same amount of data may be accumulated in the CPB for the two layers. However, because of its supplemental information, the NAL has a larger AU size than the VCL. With the CPB usage greater for the NAL than for the VCL, the amount of data accumulated for the NAL keeps getting different from that for the VCL by the amount of the supplemental information.

Where the NAL and VCL have the same bit rate, the encoding apparatus according to an embodiment of the present invention encodes data in such a manner that only the constraint on the NAL having the greater access unit data size of the two layers is met. This arrangement boosts the speed at which to encode data.

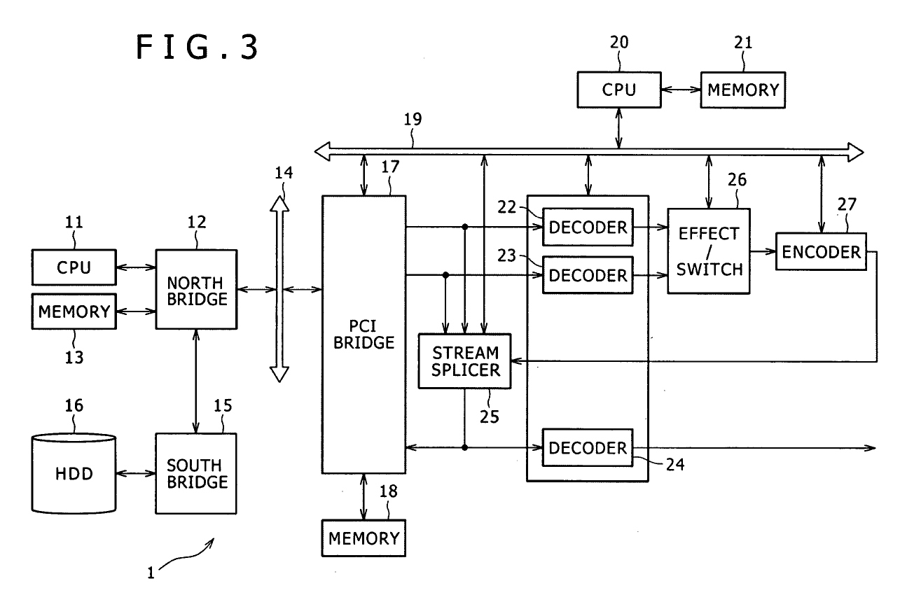

FIG. 3 is a block diagram showing a typical hardware structure of an editing apparatus 1 according to an embodiment of the present invention. A CPU (central processing unit) 11 connected to a north bridge 12 carries out diverse processes including control over the retrieval of data from a hard disk drive (HDD) 16 and generation of commands and control information for controlling the editing process to be performed by another CPU 20.

The CPU 11 may read compressed picture data (also called the materials hereunder) to be edited from the HDD 16, partially decode the data in the vicinity of an edit point, extract the partially decoded data for splicing or other edit work, and re-encode the edited data. In that case, the CPU 11 sets the range of re-encoding in such a manner that the requirements of hypothetical buffer occupancies are met upon re-encoding, that the continuity between the re-encoded part and the part not re-encoded is maintained, and that the constraints on buffer occupancies before and after the splicing point are minimized in order to allocate a sufficient amount of code to be generated. The CPU 11 further determines a floor value of the initial buffer occupancy and a ceiling value of the last buffer occupancy for a re-encoded rendering interval. In addition, the CPU 11 outputs the buffer information thus determined together with the commands for controlling the editing process to be performed by the CPU 20. How the re-encoding range is set and how the settings of the initial and last buffer occupancies for the re-encoded rendering interval are determined will be discussed later. Where the buffer-related information is determined in this manner, it becomes possible to maximize the amount of code to be generated during the re-encoded rendering interval. This in turn makes it possible to minimize the degradation of picture quality near the edit point.

The north bridge 12, connected to a PCI (Peripheral Component Interconnect/Interface) 14 and controlled by the CPU 11, receives data from the HDD 16 by way of a south bridge 15. The north bridge 12 supplies the received data to a memory 18 via the PCI bus 14 and a PCI bridge 17. The north bridge 12 is also connected to a memory 13 and exchanges therewith the data that is necessary for the CPU 11 for its processing.

The memory 13 stores the data necessary for the processes to be carried out by the CPU 11. The south bridge 15 controls the writing and reading of data to and from the HDD 16. The HDD 16 retains compression-encoded materials that may be edited.

The PCI bridge 17 controls the writing and reading of data to and from the memory 18, supplies compression-encoded data (materials) to decoders 22 through 24 or to a stream splicer 25, and controls data exchanges with the PCI bus 14 and a control bus 19. Under control of the PCI bridge 17, the memory 18 accommodates the compression-encoded data read from the HDD 16 as edit materials as well as the edited compress-on-encoded data supplied by the stream splicer 25.

The CPU 20 controls the processes to be performed by the PCI bridge 17, by the decoders 22 through 24, by the stream splicer 25, by an effect/switch 26, and by an encoder 27 in accordance with the commands and control information supplied by the CPU 11 via the PCI bus 14, PCI bridge 17, and control bus 19. A memory 21 stores the data necessary for the CPU 20 for its processing.

Under control of the CPU 20, the decoders 22 through 24 decode the supplied compression-encoded data and outputs uncompressed picture signals. The range of decoding effected by the decoders 22 and 23 may be either the same as the range of re-encoding set by the CPU 11 or a wider range that includes the range of re-encoding. The stream splicer 25 under control of the CPU 20 connects the supplied compression-encoded picture data at designated frames. The decoders 22 through 24 may be installed as devices independent of the editing apparatus 1. Illustratively, if the decoder 24 is provided as an independent device, then the decoder 24 may receive and decode the compressed picture data edited in a process, to be discussed later, and output the resulting data.

As occasion demands, the decoders 22 through 24 may decode materials for stream analysis prior to actual editing work and may inform the CPU 20 of information about the amount of code to be accumulated in the buffer. The CPU 20 informs the CPU 11 of information about the amount of code to be accumulated in the buffer during decoding by way of the control bus 19, PCI bridge 17, CPI bus 14, and north bridge 12.

Under control of the CPU 20, the effect/switch 26 switches an uncompressed picture signal output coming from the decoder 22 or 23. Specifically, the effect/switch 26 connects the supplied uncompressed picture signal at suitable frames and, after performing effects over a designated range, feeds the resulting signal to the encoder 27. The encoder 27 under control of the CPU 20 encodes that part of the uncompressed picture signal which was established as the range of re-encoding out of the supplied uncompressed picture signal. The compression-encoded picture data is output to the stream splicer 25.

In the above-described editing apparatus 1, the HDD 16 typically retains the materials which were compressed in a format defined by H.264/AVC and which are to be transferred at VBR or CBR. Given the compression-encoded picture materials held on the HDD 16, the CPU 11 acquires information about the amount of code to be generated from the materials selected for editing based on the user's operation input through an operation input section, not shown. On the basis of the information thus acquired, the CPU 11 determines the initial and the last buffer occupancies for the range of re-encoding and thereby establishes a re-encoded rendering (RR) interval. Such RR intervals that need to be handled over a prolonged time period are limited in the manner described above, while the remaining intervals are processed as smart rendering (SR) intervals in which the encoded materials can be used unmodified for fast processing. This arrangement provides a high-speed editing technique known as smart rendering.

In most cases of smart rendering, RR and SR intervals are constituted by continuous pictures. If there is a difference in picture quality at the boundary between an RR interval and an SR interval, a picture gap would occur. To bypass this bottleneck requires enhancing the picture quality for the RR interval. In the majority of cases, the RR interval length need only be prolonged in order to boost picture quality. For that reason, the shortest RR interval length is adopted on condition that no gap should occur at the splicing point between the RR and the SR intervals. These steps help to implement high-speed processing.

For example, in the editing process as per H.264/AVC, checks are made to determine if picture quality is high enough to suppress gaps in an RR interval, through calculations based on two items of information. The first item of information is the difference between the syntax hit rate and the average hit rate in the interval of interest. If the actually measured average bit rate is found to be lower than the bit rate defined in the syntax for the access unit in question, that means the picture involved is deemed structurally simple, with a limited amount of information contained therein. This type of picture is easy to enhance in quality to eliminate any gap in a shortened RR interval. That is, the information provides the basis for determining whether the RR interval tends to be shorter. The second item of information is made up of the initial_cpb_removal_delay at the beginning of a given RR interval and the initial_cpb_removal_delay at the end thereof. The initial_cpb_removal_delay denotes the amount of data being accumulated in the buffer at a given point in time. The larger the delay value, the greater the amount of data being stored in the buffer at that point in time. This information provides the basis for determining whether there is a sufficiently large amount of data that can be used in the RR interval in view of the initial/final buffer status defined by the information.

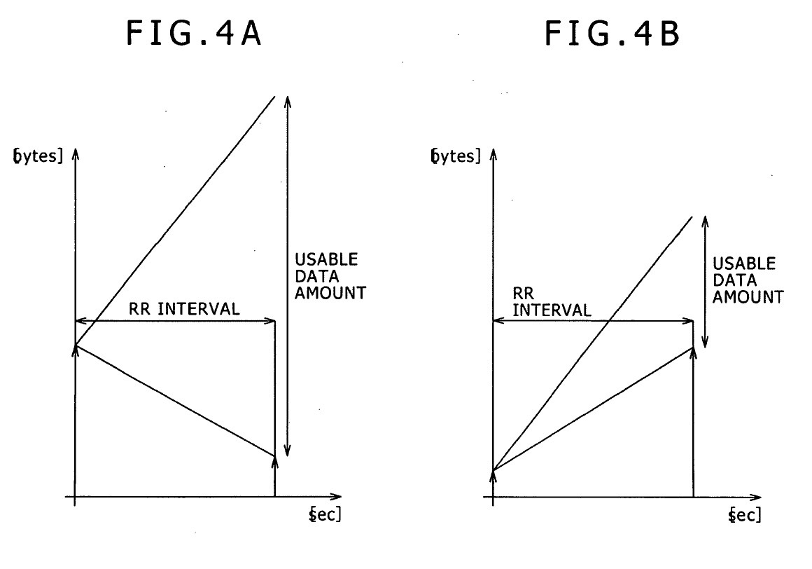

More specifically, as shown in FIG. 4A, if there is a sufficient amount of data usable at the end of the RR interval, it is possible to allocate a large amount of data for creating the picture so that picture quality can be enhanced. By contrast, as shown in FIG. 4B, if there is an insufficient amount of data that can be used at the end of the RR interval, then the interval needs to be prolonged to boost picture quality. In other words, the longer the initial_cpb_removal_delay at the beginning of the RR interval and the shorter the initial_cpb_removal_delay at the end thereof, the shorter the RR interval is deemed to get.

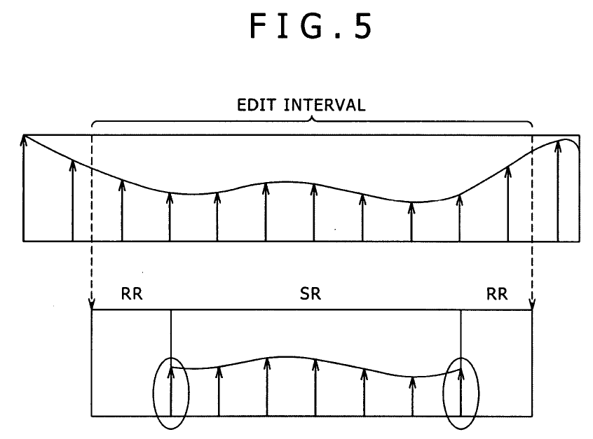

There are limits to the initial_cpb_removal_delay depending on the above-described bit stream conformance. In particular, at a boundary “a, b” between SR intervals, the SR interval length is determined by the initial_cpb_removal_delay as shown in FIG. 5. The NAL and VCL have a different initial_cpb_removal_delay each. In determining the RR interval length, the longer of the two RR interval lengths calculated separately for the NAL and VCL is selected (i.e., the severer constraint of the two).

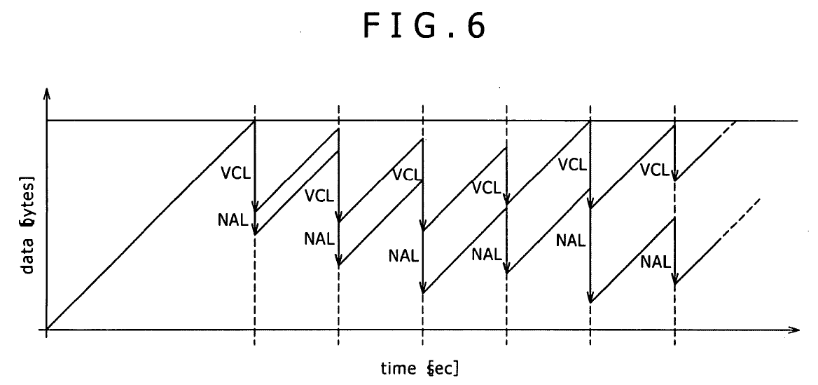

If the NAL and VCL have the same syntax bit rate as shown in FIG. 6, then the same amount of data is accumulated in the buffer for both the NAL and the VCL. However, the amount of data usage is greater for the NAL than for the VCL, the cumulative data amount for the NAL becomes progressively different from that for the VCL by the amount of supplemental information. As a result, the RR interval length calculated under the constraint on the VCL turns out to be longer than that under the constraint on the NAL.

Under the above circumstances, the editing apparatus according to an embodiment of the present invention ignores the constraint on the VCL side and utilizes only the constraint on the NAL side. This allows the selected RR interval length to become shorter than in the ordinary smart rendering process, whereby the speed of editing is increased.

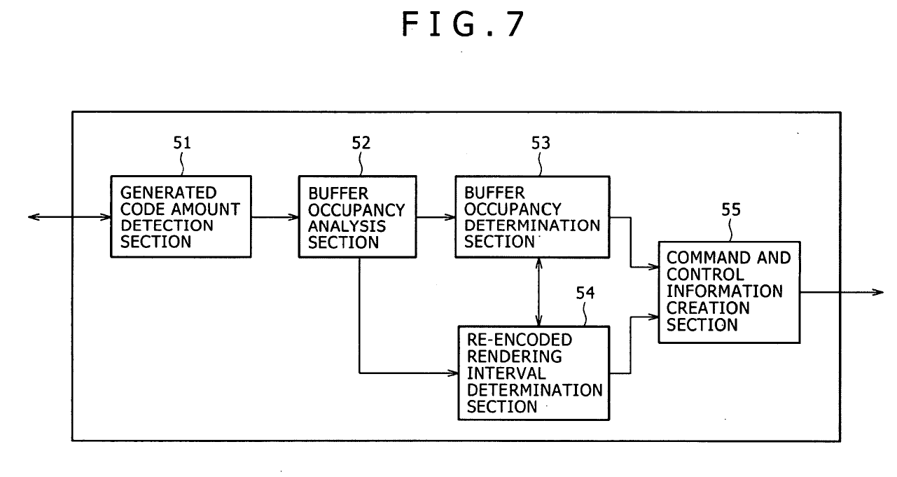

FIG. 7 is a functional block diagram outlining the function of the CPU 11 for determining the re-encoded rendering interval. A generated code amount detection section 51 detects the amount of generated code making up the material targeted for editing and stored on the HDD 16, and conveys the result of the detection to a buffer occupancy analysis section 52. The amount of generated code (i.e., amount of code between picture headers) may be detected either by analyzing the data constituting the materials held on the HDD 16 or by detecting the amount of accumulated data in the buffer through temporary decoding of data by the decoders 22 through 24.

Given information from the generated code amount detection section 51 about the amount of the generated code making up the target material, the buffer occupancy analysis section 52 analyzes model status of buffer occupancy near the splicing point between the interval where re-encoding is not carried out (i.e., SR interval) on the one hand and the re-encoded rendering interval (RR section) on the other hand. More specifically, the buffer occupancy analysis section 52 analyses buffer occupancies based on the syntax bit rates, initial_cpb_removal_delay and other factors.

The buffer occupancy analysis section 52 further analyzes the syntax bit rates of the NAL and VCL to see if the access unit bit rate is the same for the two layers. Specifically, if the difference in syntax bit rate between the NAL and the VCL is found to be equal to or less than a threshold value, then the buffer occupancy analysis section 52 determines that the bit rate is the same for the two layers. Where the access unit is the same for the two layers, only the buffer occupancy of the NAL unit is analyzed, as will be discussed later.

The buffer occupancy analysis section 52 proceeds to convey the analyzed buffer occupancies to a buffer occupancy determination section 53 and a re-encoded rendering interval determination section 54.

The buffer occupancy determination section 53 checks to see if the buffer occupancies derived from the analyses of the NAL and VCL meet bit stream conformance, and determines the buffer occupancies in keeping with the result of the check. If bit stream conformance is not found to be met, then the buffer occupancy analysis section 52 changes the initial_cpb_removal_delay value without carrying out the re-encoding. This makes it possible to convert the target material at high speed in accordance with the standard in effect.

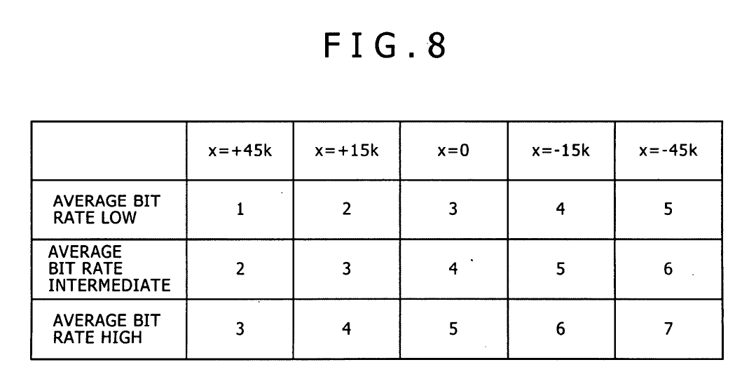

The re-encoded rendering interval determination section 54 determines the RR interval length based on the results of the buffer occupancy analyses including the syntax bit rates, average bit rates, and initial_cpb_removal_delay. Specifically, as shown in the table of FIG. 8, the RR interval length is determined based on the difference “x” between the initial_cpb_removal_delay at the beginning of a given RR interval and the initial_cpb_removal_delay at the end thereof, as well as on the average bit rates. Either the processing of the buffer occupancy determination section 53 or that of the re-encoded rendering interval determination section 54 may be carried out singly. Alternatively, the two kinds of processing may be integrated when carried out.

A command and control information creation section 55 acquires the buffer occupancies at the beginning and at the end of the re-encoded rendering interval determined by the buffer occupancy determination section 53, as well as the re-encoded rendering interval determined by the re-encoded rendering interval determination section 54. Based on the above information and information about the user-designated edit point, the command and control information creation section 55 proceeds to create an edit start command.

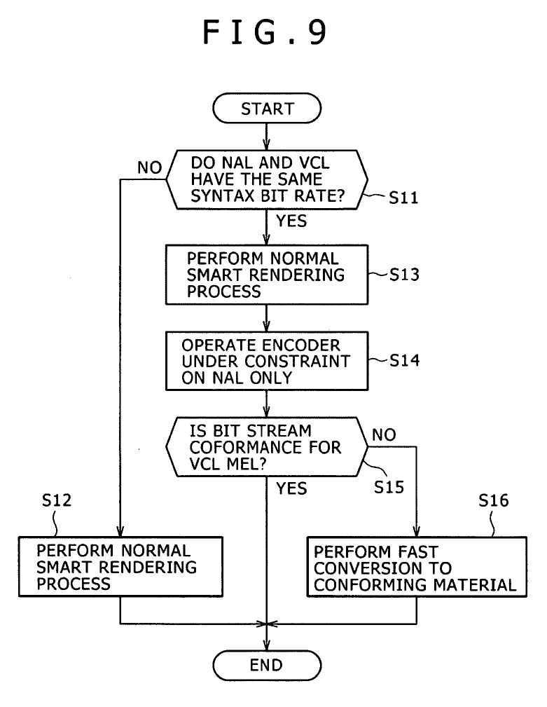

The editing process to be performed by the editing apparatus 1 of this invention will now be explained in reference to the flowchart of FIG. 9. The CPU 11 reads from the HDD 16 the encoded data in effect near the edit point of the material designated by the user through the input section, not shown.

In step S11, the buffer occupancy analysis section 52 analyzes the syntax bit rates of the NAL and VCL units near the edit point of the material targeted for editing. The buffer occupancy analysis section 52 checks to determine whether the difference between the syntax bit rates for the two layers is equal to or below a threshold value, i.e., if the two syntax bit rates are substantially the same.

If in step S11 the syntax bit rates are found different for the NAL and VCL units, then step S12 is reached and an ordinary smart rendering process is carried out. That is, the buffer occupancy analysis section 52 analyzes the buffer occupancies separately for the NAL and VCL units in order to determine an RR interval such that the buffer occupancies for the two layers will satisfy buffer conformance.

If the syntax bit rate is found to be the same for the NAL and VCL units, then the buffer occupancy analysis section 52 goes to step S13, analyzes the buffer occupancy of the NAL unit alone, and determines an RR interval such that buffer conformance is met only for the NAL unit. Since the NAL unit has a buffer occupancy smaller than that of the VCL unit, the RR interval length calculated based on the initial_cpb_removal_delay becomes shorter than the length computed in accordance with the constraint on the VCL unit. Shortening the RR interval length in this manner reduces the time it takes to execute re-encoding and thereby contributes to boosting the speed of processing. Because the buffer occupancy at the end of the RR interval is lowered significantly, it is possible to raise the ceiling value of the amount of code that can be allocated for the final frame of the RR interval. This in turn makes it possible to increase the degree of freedom in controlling the buffer occupancy in the RR interval and thereby enhance picture quality for that interval.

In step S14, the command and control information creation section 55 creates commands and control information under the constraint on the NAL unit alone, i.e., in such a manner that re-encoding is performed using the RR interval length determined by the re-encoded rendering interval determination section 54.

As discussed above, the buffer occupancy for the VCL is always greater than that for the NAL. It follows that no underflow is expected on the VCL side provided no underflow takes place on the NAL side. Still, with regard to the initial_cpb_removal_delay, there could be a case where buffer conformance is not met at the splicing point between an RR interval and an SR interval.

The above contingency is averted in step S15 in which, if re-encoding is performed under the constraint on the NAL unit alone, then the buffer occupancy determination section 53 checks to determine whether bit stream conformance is met for the VCL unit. If the conformance is found to be met, then the editing process is terminated. If the bit stream conformance for the VCL is not found to be met, then step S16 is reached.

In step S16, the buffer occupancy determination section 53 changes the initial_cpb_removal_delay for the VCL that could result in a failure to meet buffer conformance and terminates the editing process without carrying out re-encoding. The value of the initial_cpb_removal_delay is designated in the buffering interval SEI and can be changed directly. Changing the initial_cpb_removal_delay in this manner brings about conversion to the conforming material much more quickly than if re-encoding is performed. Since the time for re-encoding dominates the editing process based on H.264/AVC, the advantage of increasing the speed of encoding through the shortened RR interval length far exceeds the disadvantage of taking time for the conversion process above. This leads to a significant increase in the overall processing speed.

As described above, where the syntax bit rate is the same for the NAL and VCL, then only the NAL side is analyzed. This appreciably reduces the amount of calculations on the VCL side and lowers the buffer occupancy for the VCL, thereby boosting processing speed and enhancing picture quality.

If the analysis on the NAL side alone reveals the initial_cpb_removal_delay set for the VCL to be a nonconforming value, then the value is changed with no re-encoding carried out. This makes it possible to bring about high-speed conversion into the conforming material.

The above-described arrangements for boosting processing speed and enhancing picture quality appreciably ease the performance requirements for desired product quality levels. This translates into ever-more extensive groups of users appreciative of the target product quality than before.

Although the description above contains many specificities, these should not be construed as limiting the scope of the invention but as merely providing illustrations of some of the presently preferred embodiments of this invention. It is to be understood that changes and variations may be made without departing from the spirit or scope of the claims that follow. For example, whereas the preceding embodiment was shown to be a hardware structure, this is not limitative of the invention. Alternatively, the steps and processes involved may be turned into a computer program to be executed by a CPU (central processing unit). In this case, the computer program may be distributed recorded on a recording medium or transmitted over the Internet or through other suitable transmission media. Thus the scope of the invention should be determined by the appended claims and their legal equivalents, rather than by the examples given.

What is claimed is:

1. An encoding apparatus for putting picture data into encoded data formed by a plurality of layers conforming to a predetermined standard by use of a hypothetical buffer which hypothetically models buffer status of a decoding apparatus, said encoding apparatus comprising:
analysis means for calculating an access unit occupancy of said hypothetical buffer for each of said layers in order to determine through analysis whether constraints on said hypothetical buffer are met; and
encoding means for putting said picture data into encoded data in compliance with said predetermined standard on the basis of a result of said analysis;
wherein, if the constraint on said hypothetical buffer in a second layer is considered to be met provided the constraint on said hypothetical buffer in a first layer is met, then said analysis means calculates the access unit occupancy only for said first layer in order to determine whether the constraints on said hypothetical buffer are met.

2. The encoding apparatus according to claim 1, wherein, if the difference in bit rate between the access unit for said first layer and the access unit for said second layer is equal to or below a predetermined threshold value, then said analysis means calculates the access unit occupancy for one of the first and the second layer access units that has the larger data size of the two so as to determine through analysis whether a lower limit value of said hypothetical buffer is met and whether the constraint in terms of an initial coded picture buffer removal delay value expressed as initial_cpb_removal_delay on the access units is met.

3. The encoding apparatus according to claim 2, further comprising:
input means for designating an edit point of said picture data; and
determination means for determining a re-encoding interval including said edit point on the basis of the initial_cpb_removal_delay constraint on the access unit for the layer having said larger data size;
wherein said encoding means re-encodes the picture data in said re-encoding interval.

4. The encoding apparatus according to claim 3, wherein said determination means determines whether said second layer meets the initial_cpb_removal_delay constraint on the access unit, said determination means further rewriting the value of said initial_cpb_removal_delay constraint if the constraint is not found to be met.

5. The encoding apparatus according to claim 1, wherein said predetermined standard is H.264/AVC, and said first layer is a NAL representing a network abstraction layer and said second layer is a VCL denoting a video coding layer.

6. An encoding method for putting picture data into encoded data formed by a plurality of layers conforming to a predetermined standard by use of a hypothetical buffer which hypothetically models buffer status of a decoding apparatus, said encoding method comprising the steps of:
calculating an access unit occupancy of said hypothetical buffer for each of said layers in order to determine through analysis whether constraints on said hypothetical buffer are met; and
putting said picture data into encoded data in compliance with said predetermined standard on the basis of a result of said analysis;
wherein, if the constraint on said hypothetical buffer in a second layer is considered to be met provided the constraint on said hypothetical buffer in a first layer is met, then said calculating step calculates the access unit occupancy only for said first layer in order to determine whether the constraints on said hypothetical buffer are met.

7. A program for causing a computer to execute a procedure for putting picture data into encoded data formed by a plurality of layers conforming to a predetermined standard by use of a hypothetical buffer which hypothetically models buffer status of a decoding apparatus, said procedure comprising the steps of:
calculating an access unit occupancy of said hypothetical buffer for each of said layers in order to determine through analysis whether constraints on said hypothetical buffer are met; and
putting said picture data into encoded data in compliance with said predetermined standard on the basis of a result of said analysis;
wherein, if the constraint on said hypothetical buffer in a second layer is considered to be met provided the constraint on said hypothetical buffer in a first layer is met, then said calculating step calculates the access unit occupancy only for said first layer in order to determine whether the constraints on said hypothetical buffer are met.

8. An encoding apparatus for putting picture data into encoded data formed by a plurality of layers conforming to a predetermined standard by use of a hypothetical buffer which hypothetically models buffer status of a decoding apparatus, said encoding apparatus comprising:
an analysis section configured to calculate an access unit occupancy of said hypothetical buffer for each of said layers in order to determine through analysis whether constraints on said hypothetical buffer are met; and
an encoding section configured to put said picture data into encoded data in compliance with said predetermined standard on the basis of a result of said analysis;
wherein, if the constraint on said hypothetical buffer in a second layer is considered to be met provided the constraint on said hypothetical buffer in a first layer is met, then said analysis section calculates the access unit occupancy only for said first layer in order to determine whether the constraints on said hypothetical buffer are met.
